(19) United States
(12) Patent Application Publication
(10) Pub. No.: US 2010/0099535 A1
(43) Pub. Date: Apr. 22, 2010

(54) CONTINUOUSLY VARIABLE TRANSMISSION CONTROL APPARATUS

(75) Inventors: Yasunari Matsui, Okazaki-shi (JP); Akira Hino, Toyota-shi (JP); Naoto Tanaka, Okazaki-shi (JP); Shinya Toyoda, Nissin-shi (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/580,354

(22) Filed: Oct. 16, 2009

(30) Foreign Application Priority Data
Oct. 16, 2008 (JP) JP2008-267414

(51) Int. Cl. F16H 61/662; F16H 61/02

(52) U.S. Cl. 477/49; 477/44

(57) ABSTRACT

In an embodiment of the continuously variable transmission control apparatus of the present invention, even if an actual gear change ratio RATIO overshoots a target gear change ratio RATIO T and an upshift gear change instruction (DS1 gear change duty output) is switched to a downshift gear change instruction (DS2 gear change duty output) during gear change due to the upshift gear change instruction, in the case where the upshift gear change speed is fast, specifically, in the case where a maximum actual sheave position change ratio DWDRmax is not less than a determination threshold g, it is determined that the transmission is capable of performing an upshift gear change, and the upshift gear change state is determined to be normal. In this manner, a normalcy determination is performed more frequently.

### TECHNICAL FIELD

The present invention relates to a control apparatus of a continuously variable transmission mounted in a vehicle.

### BACKGROUND ART

This application claims priority on Japanese Patent Application No. 2008-267414 filed in Japan on Oct. 16, 2008, the entire contents of which are herein incorporated by reference.

In a vehicle in which an engine is mounted, as a transmission that appropriately transmits torque and rotational velocity generated by an engine to drive wheels according to the running state of the vehicle, an automatic transmission that automatically sets an optimal gear ratio between the engine and the drive wheels is known.

Automatic transmissions mounted in a vehicle include, for example, planetary gear-type transmissions that set a gear ratio using a planetary gear apparatus and frictionally engaging elements such as a clutch and a brake, and belt-type continuously variable transmissions (CVTs) that continuously adjust the gear ratio.

In the configuration of a belt-type continuously variable transmission, a belt is wrapped around a primary pulley (input side pulley) and a secondary pulley (output side pulley) that are provided with a pulley groove (V groove), and by reducing the groove width of the pulley groove of one pulley while increasing the groove width of the pulley groove of the other pulley, the contact radius (effective diameter) of the belt to each of the pulleys is continuously changed to steplessly set a gear ratio. The torque transmitted in this belt-type continuously variable transmission corresponds to the load that acts in the direction that the belt and the pulleys are made to contact each other. Accordingly, the belt is clamped by the pulleys such that tension is applied to the belt.

Also, gear changes of the belt-type continuously variable transmission, for example, are performed in the following manner: a target gear ratio (target revolutions on the input side of the transmission) is calculated based on an acceleration operation amount that represents an output amount requested by the driver and the vehicle speed; and a movable sheave of the primary pulley is moved with a hydraulic actuator provided on the back face side thereof so as to enlarge or reduce the groove width of the pulley grooves, thereby matching an actual gear ratio to that target gear ratio.

In this sort of belt-type continuously variable transmission, for example as disclosed in JP 2007-177833A (Patent Document 1), the gear ratio is controlled using an upshift gear change control valve and a downshift gear change control valve. A line pressure is supplied to these two gear change control valves as a source pressure.

A duty solenoid valve (below, also referred to as a gear change control solenoid) is connected to the upshift gear change control valve and the downshift gear change control valve. The gear change control solenoid operates in response to an upshift gear change instruction or a downshift gear change instruction, and the upshift gear change control valve and the downshift gear change control valve are switched according to a control hydraulic pressure that is output by the gear change control solenoid. Thus, the amount of oil supplied to the hydraulic actuator of the primary pulley via the upshift gear change control valve and the amount of oil discharged from the hydraulic actuator of the primary pulley via the downshift gear change control valve are controlled. By controlling the flow-in/flow-out amount of hydraulic fluid of the hydraulic actuator of the primary pulley in this way, the groove width of the primary pulley, i.e., the belt contact radius of the primary pulley side, changes; thus, the gear ratio is controlled.

Also, a belt-clamping pressure control valve is connected to the hydraulic actuator of the secondary pulley. Line pressure is supplied to the belt-clamping pressure control valve, and by supplying that line pressure to the hydraulic actuator of the secondary pulley by controlling the control hydraulic pressure output by the linear solenoid valve as a pilot pressure, the belt-clamping pressure is controlled.

The line pressure used for the above gear change control and belt-clamping pressure control is produced by using a line pressure control valve (primary regulator valve) to adjust the hydraulic pressure generated by an oil pump The line pressure control valve is configured to operate using a control hydraulic pressure that is output by a linear solenoid valve for line pressure control as a pilot pressure.

### DISCLOSURE OF INVENTION

### Problem to be Solved by the Invention

In the above-described belt-type continuously variable transmission, normalcy determination (normalcy determination of the gear change state) is performed on gear change-related components such as a gear change control solenoid. Specifically, for example, the upshift gear change state is determined to be normal when a determination condition is satisfied that an upshift gear change instruction is present and also the ratio of an actual sheave position movement amount relative to a target sheave position movement amount of the movable sheave of the primary pulley is not less than a prescribed value. However, in the gear change control in the belt-type continuously variable transmission, for example, when the upshift gear change speed is fast so that the actual gear ratio overshoots the target gear ratio, the upshift gear change instruction is switched to a downshift gear change instruction (see FIG. 9, for example). In such a state, although the transmission is capable of performing an upshift gear change, the above-described determination condition fails to be satisfied so that the normalcy determination is terminated. As a result, the normalcy determination of the upshift gear change state may be performed less frequently.

The present invention was made in consideration of such circumstances, and it is an object thereof to provide a continuously variable transmission control apparatus that can perform such normalcy determination of the upshift gear change state more frequently.

### Means for Solving Problem

The present invention assumes a continuously variable transmission control apparatus including: a primary pulley; a secondary pulley; a belt wrapped around the primary pulley and the secondary pulley; an actuator that changes a groove width of a pulley groove by moving a sheave of the primary pulley; a gear change control means for performing gear change by controlling the actuator in response to an upshift gear change instruction or a downshift gear change instruction; a normalcy determination means for determining that an upshift gear change state is normal when the upshift gear change instruction is present, and that a following degree of an actual gear ratio relative to a target gear ratio is not less than a normalcy determination threshold. In such a continuously variable transmission control apparatus, even if the upshift gear change instruction ceases during an upshift gear change, the normalcy determination means determines that an upshift gear change state is normal in a case where the following degree of an actual gear ratio relative to a target gear ratio is not less than the normalcy determination threshold, and a maximum value of a gear change speed during an upshift gear change is not less than a determination threshold.

As an example of a specific configuration of the present invention, it is possible to adopt a configuration in which it is determined that an upshift gear change state is normal when the upshift gear change instruction is present, and a ratio of an actual sheave position movement amount relative to a target sheave position movement amount of the sheave of the primary pulley is not less than a normalcy determination threshold, and even if the upshift gear change instruction ceases during an upshift gear change, determines that the upshift gear change state is normal in a case where the ratio of the actual sheave position movement amount relative to the target sheave position movement amount is not less than the normalcy determination threshold, and a maximum actual sheave position change ratio of the sheave of the primary pulley during upshift gear change is not less than a determination threshold. More specifically, it is possible to adopt a configuration in which an actuator of the primary pulley is a hydraulic actuator that is driven by flow-in or flow-out of a hydraulic fluid, and is configured such that the amount of flow-in or flow-out of the hydraulic fluid in the hydraulic actuator is controlled with a solenoid valve, and the upshift gear change instruction is an upshift gear change duty signal output to the solenoid valve.

### Effects of the Invention

According to the invention, even if an actual gear ratio overshoots a target gear ratio during a gear change performed due to an upshift gear change instruction and the upshift gear change instruction is switched to a downshift gear change instruction, in the case where the upshift gear change speed is fast (a maximum actual sheave position change ratio is not less than a determination threshold), it is determined that the transmission is capable of performing upshift gear change, and thus the upshift gear change state is determined to be normal. As a result, the normalcy determination can be performed more frequently.

### BRIEF DESCRIPTION OF DRAWINGS

FIG. 1 is a schematic configuration view that shows an example of a vehicle in which has been mounted a belt-type continuously variable transmission in which the present invention is applied.

FIG. 2 is a circuit configuration view of, in a hydraulic pressure control circuit according to an embodiment of the present invention, a hydraulic pressure control circuit that controls a hydraulic actuator of a primary pulley of a belt-type continuously variable transmission.

FIG. 3 is a circuit configuration view of, in a hydraulic pressure control circuit according to an embodiment of the present invention, a hydraulic pressure control circuit that controls the belt-clamping pressure of the belt-type continuously variable transmission.

FIG. 4 shows an example of a map used for gear change control of the belt-type continuously variable transmission according to an embodiment of the present invention.

FIG. 5 shows an example of a map used for belt-clamping pressure control of the belt-type continuously variable transmission according to an embodiment of the present invention.

FIG. 6 is a block diagram that shows the configuration of a control system such as an ECU according to an embodiment of the present invention.

FIG. 7 is a flowchart that shows an example of a control routine of a normalcy determination process of an upshift gear change state according to an embodiment of the present invention.

FIG. 8 is a timing chart that shows change in a target gear ratio and an actual gear ratio during an upshift gear change according to an embodiment of the present invention.

FIG. 9 is a timing chart that shows another example of change in a target gear ratio and an actual gear ratio during an upshift gear change according to an embodiment of the present invention.

### BEST MODE FOR CARRYING OUT THE INVENTION

Following is a description of embodiments of the present invention, with reference to the drawings.

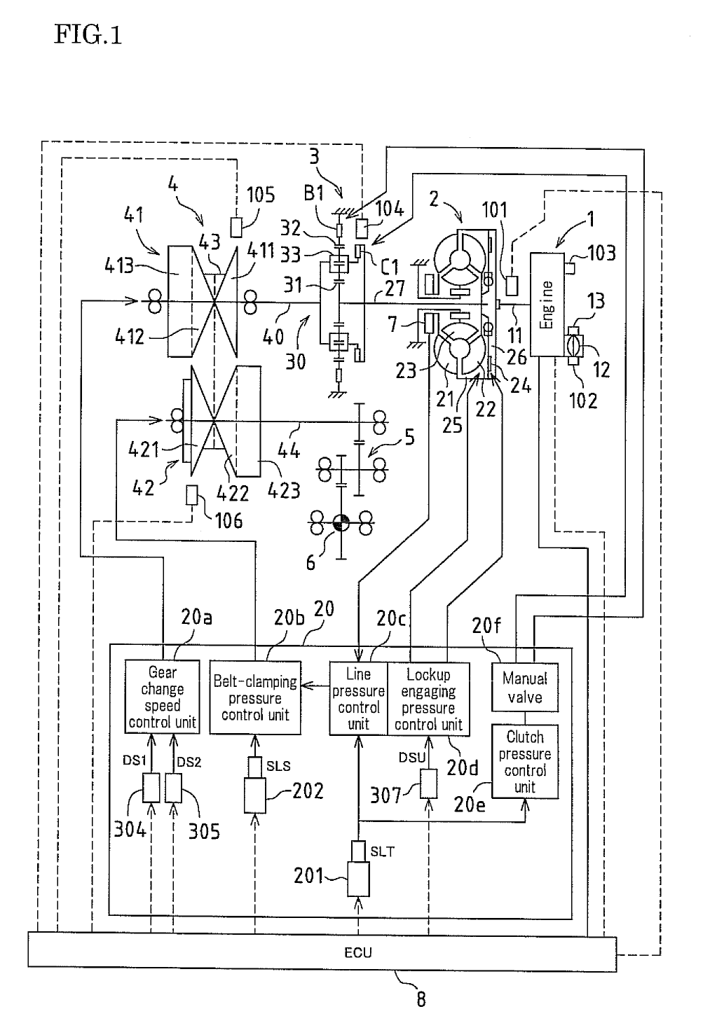

FIG. 1 is a schematic configuration view of a vehicle in which the present invention is applied.

The vehicle in this example is a FF (front engine/front drive) type vehicle, in which an engine (internal combustion engine) 1 that is a travel power source, a torque converter 2 serving as fluid transmission apparatus, a forward/rearward travel switching apparatus 3, a belt-type continuously variable transmission (CVT) 4, a deceleration gear apparatus 5, a differential gear apparatus 6, an ECU (Electronic Control Unit) 8, and so on are mounted. A belt-type continuously variable transmission control apparatus is realized with the ECU 8, a hydraulic pressure control circuit 20 described below, a primary pulley revolutions sensor 105, a secondary pulley revolutions sensor 106, and so forth.

A crank shaft 11 that is an output shaft of the engine 1 is linked to the torque converter 2, and output of the engine 1 is transmitted from the torque converter 2 to the differential gear apparatus 6 via the forward/rearward travel switching apparatus 3, the belt-type continuously variable transmission 4, and the deceleration gear apparatus 5, and distributed to left and right drive wheels (not shown).

The engine 1, the torque converter 2, the forward/rearward travel switching apparatus 3, the belt-type continuously variable transmission 4, and the ECU 8 are each described below.

—Engine—

The engine 1 is, for example, a multi-cylinder gasoline engine. The intake amount of air drawn into the engine 1 is controlled by an electronically controlled throttle valve 12. A throttle opening degree of the throttle valve 12 can be electronically controlled independent from accelerator pedal operation of a driver, and that opening degree (throttle opening degree) is detected with a throttle opening degree sensor 102. Also, the cooling water temperature of the engine 1 is detected with a water temperature sensor 103.

The throttle opening degree of the throttle valve 12 is driven/controlled with the ECU 8. Specifically, the throttle opening degree of the throttle valve 12 is controlled so as to obtain an optimal air intake amount (target intake amount) according to the operational state of the engine 1 such as engine revolutions Ne detected by an engine revolutions sensor 101 and the driver's accelerator pedal depression amount (accelerator operation amount Acc). More specifically, the actual throttle opening degree of the throttle valve 12 is detected using the throttle opening degree sensor 102, and a throttle motor 13 of the throttle valve 12 is feedback-controlled such that the actual throttle opening degree matches the throttle opening degree that can obtain the target intake amount (target throttle opening degree).

—Torque Converter—The torque converter 2 is provided with an input side pump impeller 21, an output side turbine runner 22, a stator 23 that realizes a torque amplification function, and the like, and transmits power between the pump impeller 21 and the turbine runner 22 via a fluid. The pump impeller 21 is linked to the crank shaft 11 of the engine 1. The turbine runner 22 is linked to the forward/rearward travel switching apparatus 3 via a turbine shaft 27.

In the torque converter 2, a lockup clutch 24 is provided that puts the input side and the output side of the torque converter 2 into a directly linked state. By controlling a differential pressure (lockup differential pressure) between the hydraulic pressure in an engaging side oil chamber 25 and the hydraulic pressure in a releasing side oil chamber 26, the lockup clutch 24 is completely engaged, half engaged (engagement in a slippage state), or released.

By completely engaging the lockup clutch 24, the pump impeller 21 and the turbine runner 22 rotate as a single body. Alternatively, by engaging the lockup clutch 24 in a predetermined slippage state (half engaged state), the turbine runner 22 rotates following the pump impeller 21 with a predetermined slippage amount during driving. On the other hand, the lockup clutch 24 is released by setting a negative lockup differential pressure.

Also, in the torque converter 2, a mechanical oil pump (hydraulic pressure generation source) 7 is provided that is driven while linked to the pump impeller 21.

—Forward/Rearward Travel Switching Apparatus—The forward/rearward travel switching apparatus 3 is provided with a double pinion-type planetary gear mechanism 30, a forward clutch (input clutch) C1, and a rearward brake B1.

A sun gear 31 of the planetary gear mechanism 30 is linked as a single body to the turbine shaft 27 of the torque converter 2, and a carrier 33 is linked as a single body to an input shaft 40 of the belt-type continuously variable transmission 4. Also, the carrier 33 and the sun gear 31 are selectively linked via the forward clutch C1, and a ring gear 32 is selectively fixed to a housing via the rearward brake B1.

The forward clutch Cl and the rearward brake B1 are hydraulic pressure-type frictionally engaging elements that are engaged/released with the hydraulic pressure control circuit 20, described below. Due to the forward clutch C1 being engaged and the rearward brake B1 being released, the forward/rearward travel switching apparatus 3 rotates as a single body; thus, a forward power transmission path is established (attained), and in this state, drive power in the forward direction is transmitted to the belt-type continuously variable transmission 4 side.

On the other hand, when the rearward brake B1 is engaged and the forward clutch C1 is released, a rearward power transmission path is established (attained) with the forward/rearward travel switching apparatus 3. In this state, the input shaft 40 rotates in the opposite direction as the turbine shaft 27, and this drive power in the rearward direction is transmitted to the belt-type continuously variable transmission 4 side. Alternatively, when the forward clutch C1 and the rearward brake B1 are both released, the forward/rearward travel switching apparatus 3 enters a neutral state (blocked state) in which power transmission is blocked.

—Belt-Type Continuously Variable Transmission—

The belt-type continuously variable transmission 4 is provided with an input side primary pulley 41, an output side secondary pulley 42, and a metal belt 43 that is wrapped around the primary pulley 41 and the secondary pulley 42.

The primary pulley 41 is a variable pulley whose effective diameter is variable, and is configured with a fixed sheave 411 that is fixed to the input shaft 40 and a movable sheave 412 that is disposed on the input shaft 40 in a state so as to be slidable only in the axial direction. The secondary pulley 42 likewise is a variable pulley whose effective diameter is variable, and is configured with a fixed sheave 421 that is fixed to an output shaft 44 and a movable sheave 422 that is disposed on the output shaft 44 in a state so as to be slidable only in the axial direction.

A hydraulic actuator 413 for changing the V groove width between the fixed sheave 411 and the movable sheave 412 is disposed on the movable sheave 412 side of the primary pulley 41. Likewise, a hydraulic actuator 423 for changing the V groove width between the fixed sheave 421 and the movable sheave 422 is disposed on the movable sheave 422 side of the secondary pulley 42.

In the belt-type continuously variable transmission 4 with the above structure, by controlling the hydraulic pressure of the hydraulic actuator 413 of the primary pulley 41, the respective V groove widths of the primary pulley 41 and the secondary pulley 42 change; thus, the contact diameter (effective diameter) of the belt 43 changes, so that a gear ratio γ (γ=primary pulley revolutions (input shaft revolutions) Nin/secondary pulley revolutions (output shaft revolutions) Nout) changes continuously. Also, the hydraulic pressure of the hydraulic actuator 423 of the secondary pulley 42 is controlled such that the belt 43 is clamped at a predetermined clamping pressure at which belt slippage does not occur. These controls are executed with the ECU 8 and the hydraulic pressure control circuit 20.

—Hydraulic Pressure Control Circuit—

As shown in FIG. 1, the hydraulic pressure control circuit 20 is configured with a gear change speed control unit 20a, a belt-clamping pressure control unit 20b, a line pressure control unit 20c, a lockup engaging pressure control unit 20d, a clutch pressure control unit 20e, a manual valve 20f, and so on.

Also, control signals are supplied from the ECU 8 to a gear change control solenoid (DS1) 304 and a gear change control solenoid (DS2) 305 for gear change speed control, a linear solenoid (SLS) 202 for belt-clamping pressure control, a linear solenoid (SLT) 201 for line pressure control, and a duty solenoid (DSU) 307 for lockup engaging pressure control, which constitute the hydraulic pressure control circuit 20.

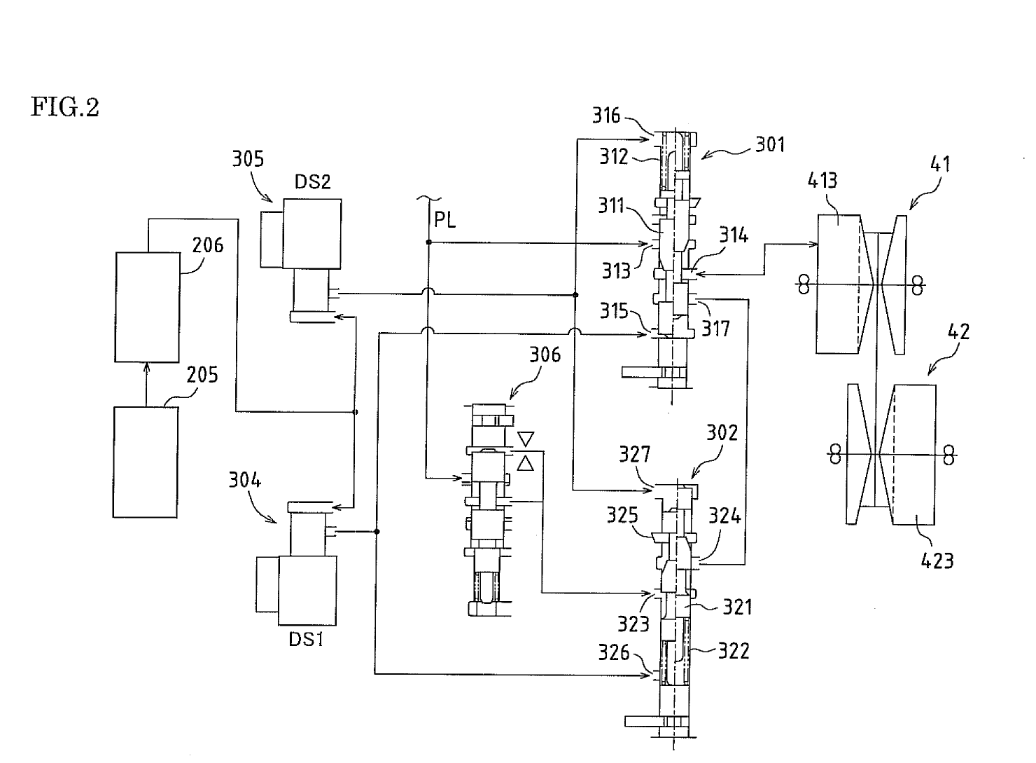

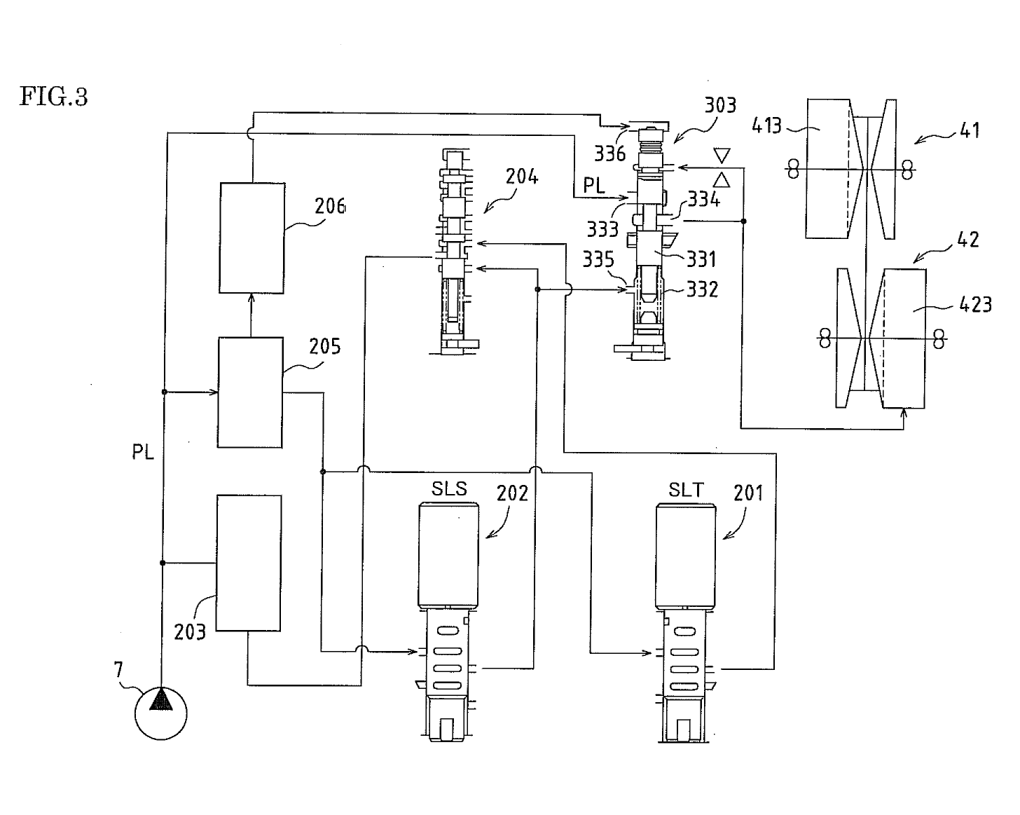

Next, with reference to FIGS. 2 and 3, is a description of, among the hydraulic pressure control circuits 20, a hydraulic pressure control circuit (specific hydraulic pressure circuit configuration of the gear change speed control unit 20a) of the hydraulic actuator 413 of the primary pulley 41 of the belt-type continuously variable transmission 4, and a hydraulic pressure control circuit (specific hydraulic pressure circuit configuration of the belt-clamping pressure control unit 20b) of the hydraulic actuator 423 of the secondary pulley 42.

First, as shown in FIG. 3, the hydraulic pressure generated by the oil pump 7 is adjusted by a primary regulator valve 203 to produce a line pressure PL. A control hydraulic pressure output by the linear solenoid (SLT) 201 is supplied to the primary regulator valve 203 via a clutch application control valve 204, and that control hydraulic pressure acts as a pilot pressure.

Through switching of the clutch application control valve 204, the control hydraulic pressure from the linear solenoid (SLS) 202 is supplied to the primary regulator valve 203, and the line pressure PL may be adjusted by using that control hydraulic pressure as the pilot pressure. The hydraulic pressure adjusted with a modulator valve 205 using the line pressure PL as a source pressure is supplied to the linear solenoid (SLT) 201 and the linear solenoid (SLS) 202.

The linear solenoid (SLT) 201 outputs a control hydraulic pressure according to a current value determined with a duty signal that has been sent from the ECU 8. The linear solenoid (SLT) 201 is a normally open-type solenoid valve.

Also, the linear solenoid (SLS) 202 outputs a control hydraulic pressure according to a current value determined with a duty signal that has been sent from the ECU 8. Like the above linear solenoid (SLT) 201, the linear solenoid (SLS) 202 also is a normally open-type solenoid valve.

Note that in the hydraulic pressure control circuits shown in FIGS. 2 and 3, a modulator valve 206 adjusts the hydraulic pressure output by the modulator valve 205 to a fixed pressure, and supplies the adjusted hydraulic pressure to the below-described gear change control solenoid (DS1) 304, gear change control solenoid (DS2) 305, a belt-clamping pressure control valve 303, and so on.

[Gear Change Control]

Next is a description of the hydraulic pressure control circuit of the hydraulic actuator 413 of the primary pulley 41. As shown in FIG. 2, an upshift gear change control valve 301 is connected to the hydraulic actuator 413 of the primary pulley 41.

In the upshift gear change control valve 301, a spool 311 is provided that can move in the axial direction. A spring 312 is disposed at one end (the upper end in FIG. 2) of the spool 311, and a first hydraulic pressure port 315 is formed at the opposite end from the spring 312, with the spool 311 therebetween. Also, a second hydraulic pressure port 316 is formed at the end where the spring 312 is disposed.

The gear change control solenoid (DS1) 304, which outputs a control hydraulic pressure according to a current value determined with a duty signal (DS1 gear change duty (upshift duty)) that has been sent from the ECU 8, is connected to the first hydraulic pressure port 315, and the control hydraulic pressure output by the gear change control solenoid (DS1) 304 is applied to the first hydraulic pressure port 315. The gear change control solenoid (DS2) 305, which outputs a control hydraulic pressure according to a current value determined with a duty signal (DS2 gear change duty (downshift duty)) that has been sent from the ECU 8, is connected to the second hydraulic pressure port 316, and the control hydraulic pressure output by the gear change control solenoid (DS2) 305 is applied to the second hydraulic pressure port 316.

Further, in the upshift gear change control valve 301, an input port 313 where the line pressure PL is supplied, an input/output port 314 connected to (in communication with) the hydraulic actuator 413 of the primary pulley 41, and an output port 317 are formed. When the spool 311 is in an upshift position (right side position in FIG. 2), the output port 317 is closed, and line pressure PL is supplied from the input port 313 to the hydraulic actuator 413 of the primary pulley 41 via the input/output port 314. On the other hand, when the spool 311 is in a closed position (left side position in FIG. 2), the input port 313 is closed, and the hydraulic actuator 413 of the primary pulley 41 is in communication with the output port 317 via the input/output port 314.

A spool 321 that is movable in the axial direction is provided in a downshift gear change control valve 302. A spring 322 is disposed at one end (the lower end in FIG. 2) of the spool 321, and a first hydraulic pressure port 326 is formed at that end. Also, a second hydraulic pressure port 327 is formed at the opposite end from the spring 322, with the spool 321 therebetween. The gear change control solenoid (DS1) 304 is connected to the first hydraulic pressure port 326, and the control hydraulic pressure output by the gear change control solenoid (DS1) 304 is applied to the first hydraulic pressure port 326. The gear change control solenoid (DS2) 305 is connected to the second hydraulic pressure port 327, and the control hydraulic pressure output by the gear change control solenoid (DS2) 305 is applied to the second hydraulic pressure port 327.

Further, an input port 323, an input/output port 324 and a discharge port 325 are formed in the downshift gear change control valve 302. A bypass control valve 306 is connected to the input port 323, and a hydraulic pressure obtained by adjusting the line pressure PL at the bypass control valve 306 is supplied. In this sort of downshift gear change control valve 302, the input/output port 324 is in communication with the discharge port 325 when the spool 321 is in the downshift position (left side position in FIG. 2). On the other hand, the input/output port 324 is closed when the spool 321 is in the closed position (right side position in FIG. 2). Also, the input/output port 324 of the downshift gear change control valve 302 is connected to the output port 317 of the upshift gear change control valve 301.

In the above hydraulic pressure control circuit of FIG. 2, when the gear change control solenoid (DS1) 304 operates in response to a DS1 gear change duty (upshift gear change instruction) output by the ECU 8, and the control hydraulic pressure output by the gear change control solenoid (DS1) 304 is supplied to the first hydraulic pressure port 315 of the upshift gear change control valve 301, the spool 311 moves to the upshift position side (upper side in FIG. 2) due to thrust corresponding to that control hydraulic pressure. Due to movement (movement to the upshift side) of the spool 311, hydraulic fluid (the line pressure PL) is supplied from the input port 313 via the input/output port 314 to the hydraulic actuator 413 of the primary pulley 41 at a flow amount corresponding to the control hydraulic pressure, and the output port 317 is closed so that the hydraulic fluid is prevented from flowing through to the downshift gear change control valve 302. Thus, the gear change control pressure is increased, the V groove width of the primary pulley 41 is reduced, and so the gear ratio γ is reduced (upshift).

When the control hydraulic pressure output by the gear change control solenoid (DS1) 304 is supplied to the first hydraulic pressure port 326 of the downshift gear change control valve 302, the spool 321 moves to the upper side in FIG. 2, and so the input/output port 324 is closed.

On the other hand, when the gear change control solenoid (DS2) 305 operates in response to a DS2 gear change duty (downshift gear change instruction) output by the ECU 8, and the control hydraulic pressure output by the gear change control solenoid (DS2) 305 is supplied to the second hydraulic pressure port 316 of the upshift gear change control valve 301, the spool 311 moves to the downshift position side (lower side in FIG. 2) due to thrust corresponding to that control hydraulic pressure. Due to movement (movement to the downshift side) of the spool 311, hydraulic fluid in the hydraulic actuator 413 of the primary pulley 41 flows into the input/output port 314 of the upshift gear change control valve 301 at a flow amount corresponding to the control hydraulic pressure. The hydraulic fluid that flowed into the upshift gear change control valve 301 is discharged from the discharge port 325 via the output port 317 and the input/output port 324 of the downshift gear change control valve 302. Thus, the gear change control pressure is reduced, the V groove width of the input side variable pulley 42 is increased, and so the gear ration γ is increased (downshift).

When the control hydraulic pressure output by the gear change control solenoid (DS2) 305 is supplied to the second hydraulic pressure port 327 of the downshift gear change control valve 302, the spool 321 moves to the lower side in FIG. 2, so that the input/output port 324 and the discharge port 325 are in communication.

When, as described above, control hydraulic pressure is output from the gear change control solenoid (DS1) 304, hydraulic fluid from the upshift gear change control valve 301 is supplied to the hydraulic actuator 413 of the primary pulley 41, and the gear change control pressure is continuously shifted up. Alternatively, when control hydraulic pressure is output from the gear change control solenoid (DS2) 305, hydraulic fluid in the hydraulic actuator 413 of the primary pulley 41 is discharged from the discharge port 325 of the downshift gear change control valve 302, and the gear change control pressure is continuously shifted down.

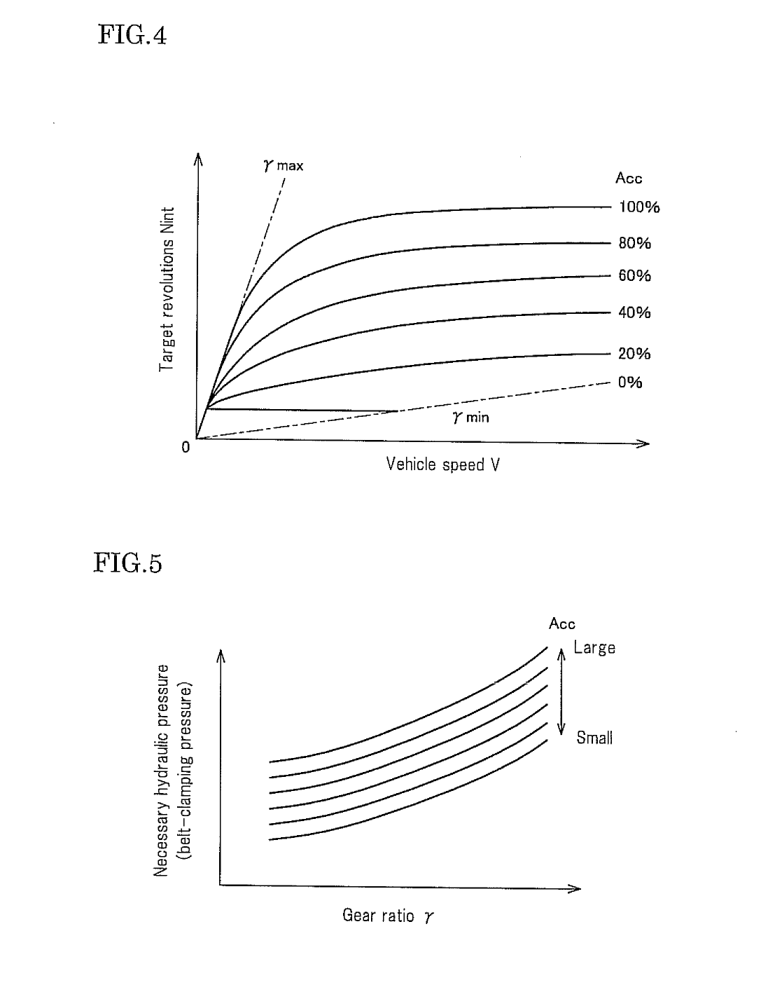

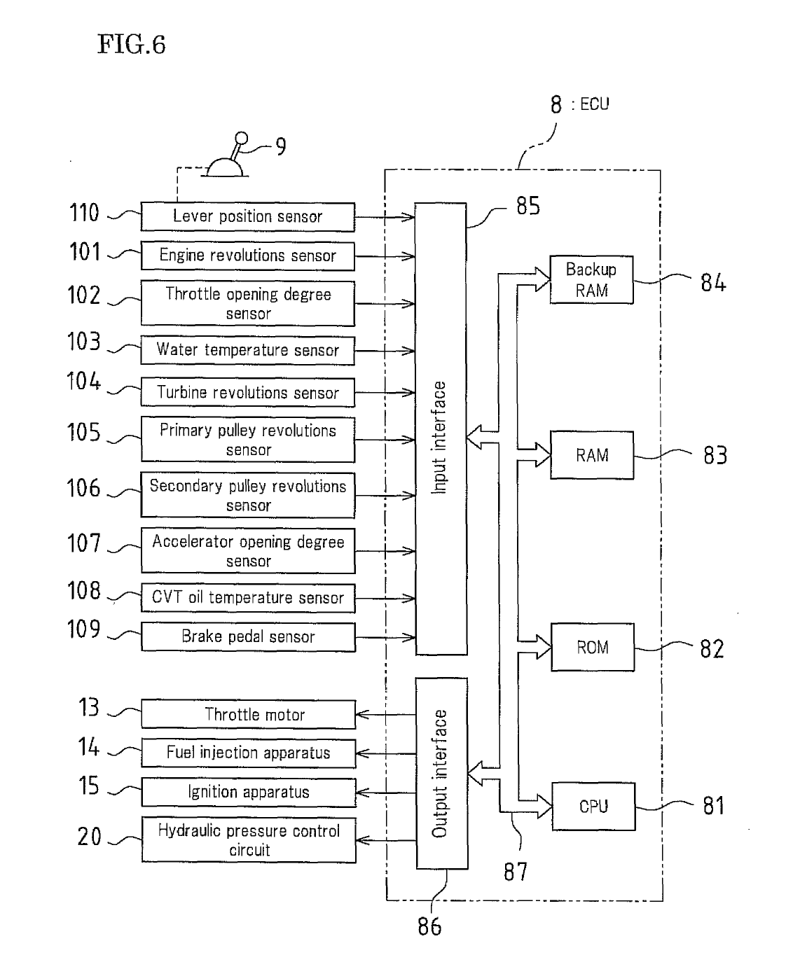

In this example, as shown in FIG. 4 for example, input side target revolutions Nint are calculated from a preset gear change map using an accelerator operation amount Acc that indicates the driver's requested output and a vehicle speed V as parameters, and gear change control of the belt-type continuously variable transmission 4 is performed such that actual input shaft revolutions Nin match the target revolutions Nint, according to the difference between those revolutions (Nint−Nin). That is, gear change control pressure is controlled by supply/discharge of hydraulic fluid to or from the hydraulic actuator 413 of the primary pulley 41; thus, the gear ration γ changes continuously. The map in FIG. 4 corresponds to the gear change conditions, and is stored in a ROM 82 of the ECU 8 (see FIG. 6).

In the map in FIG. 4, the target revolutions Nint are set such that the gear ration γ increases as the vehicle speed V decreases and the accelerator operation amount Acc increases. Also, because the vehicle speed V corresponds to the secondary pulley revolutions (output shaft revolutions) Nout, the target revolutions Nint that are the target value of the primary pulley revolutions (input shaft revolutions) Nin correspond to the target gear ratio, and are set within the range of a minimum gear ratio γmin and a maximum gear ratio γmax of the belt-type continuously variable transmission 4.

[Belt-Clamping Pressure Control]

Next is a description of a hydraulic pressure control circuit of the hydraulic actuator 423 of the secondary pulley 42, with reference to FIG. 3.

As shown in FIG. 3, the belt-clamping pressure control valve 303 is connected to the hydraulic actuator 423 of the secondary pulley 42.

In the belt-clamping pressure control valve 303, a spool 331 is provided that can move in the axial direction. A spring 332 is disposed at one end (the lower end in FIG. 3) of the spool 331, and a first hydraulic pressure port 335 is formed at that end. Also, a second hydraulic pressure port 336 is formed at the opposite end from the spring 332, with the spool 331 therebetween.

The linear solenoid (SLS) 202 is connected to the first hydraulic pressure port 335, and control hydraulic pressure output by the linear solenoid (SLS) 202 is applied to the first hydraulic pressure port 335. Hydraulic pressure from the modulator valve 206 is applied to the second hydraulic pressure port 336.

Further, in the belt-clamping pressure control valve 303, an input port 333 where the line pressure PL is supplied, and an output port 334 connected to (in communication with) the hydraulic actuator 423 of the secondary pulley 42, are formed.

In the hydraulic pressure control circuit in FIG. 3, from a state in which a predetermined hydraulic pressure is being supplied to the hydraulic actuator 423 of the secondary pulley 42, when the control hydraulic pressure output by the linear solenoid (SLS) 202 increases, the spool 331 of the belt-clamping pressure control valve 303 moves to the upper side in FIG. 3. In this case, the hydraulic pressure supplied to the hydraulic actuator 423 of the secondary pulley 42 increases, and the belt-clamping pressure increases.

On the other hand, from a state in which a predetermined hydraulic pressure is being supplied to the hydraulic actuator 423 of the secondary pulley 42, when the control hydraulic pressure output by the linear solenoid (SLS) 202 decreases, the spool 331 of the belt-clamping pressure control valve 303 moves to the lower side in FIG. 3. In this case, the hydraulic pressure supplied to the hydraulic actuator 423 of the secondary pulley 42 decreases, and the belt-clamping pressure decreases.

In this way, the line pressure PL is adjusted or controlled using the control hydraulic pressure output by the linear solenoid (SLS) 202 as a pilot pressure, and the belt-clamping pressure increases or decreases due to the supply of the adjusted line pressure PL to the hydraulic actuator 423 of the secondary pulley 42.

In this example, as shown in FIG. 5 for example, the control hydraulic pressure output by the linear solenoid (SLS) 202 is controlled according to a map of necessary hydraulic pressures (corresponding to belt-clamping pressure) that has been preset such that belt slippage does not occur, using an accelerator opening degree Acc that corresponds to the transmitted torque and the gear ration γ (γ=Nin/Nout) as parameters; thus, the belt-clamping pressure of the belt-type continuously variable transmission 4 is controlled. That is, the belt-clamping pressure of the belt-type continuously variable transmission 4 is controlled by adjusting or controlling the hydraulic pressure of the hydraulic actuator 423 of the secondary pulley 42. The map in FIG. 5 corresponds to the clamping pressure control conditions, and is stored in the ROM 82 of the ECU 8 (see FIG. 6).

—ECU—

As shown in FIG. 6, the ECU 8 is provided with a CPU 81, the ROM 82, a RAM 83, a backup RAM 84, and so on.

Various control programs, maps referred to when executing those various programs, and the like are stored in the ROM 82. The CPU 81 executes various computational processes based on the various control programs and maps stored in the ROM 82. The RAM 83 is a memory that temporarily stores the results of computation by the CPU 81, data that has been input from various sensors, and the like. The backup RAM 84 is a nonvolatile memory that stores data to be saved when the engine 1 is stopped, or the like.

The CPU 81, the ROM 82, the RAM 83, and the backup RAM 84 are connected to each other via a bus 87, and are connected to an input interface 85 and an output interface 86.

The engine revolutions sensor 101, the throttle opening degree sensor 102, the water temperature sensor 103, a turbine revolutions sensor 104, the primary pulley revolutions sensor 105, the secondary pulley revolutions sensor 106, an accelerator opening degree sensor 107, a CVT oil temperature sensor 108, a brake pedal sensor 109, a lever position sensor 110 that detects the lever position (operation position) of a shift lever 9, and so on are connected to the input interface 85 of the ECU 8. Output signals of those respective sensors, i.e., signals that indicate, for example, engine 1 revolutions (engine revolutions) Ne, throttle valve 12 throttle opening degree θth, engine 1 coolant water temperature Tw, turbine shaft 27 revolutions (turbine revolutions) Nt, primary pulley revolutions (input shaft revolutions) Nin, secondary pulley revolutions (output shaft revolutions) Nout, accelerator pedal operation amount (accelerator opening degree) Acc, hydraulic pressure control circuit 20 oil temperature (CVT oil temperature Thc), whether or not a foot brake that is an ordinary brake is operated (brake ON/OFF), shift lever 9 lever position (operation position), and so on are supplied to the ECU 8.

The throttle motor 13, a fuel injection apparatus 14, an ignition apparatus 15, the hydraulic pressure control circuit 20 (lockup control circuit), and so on are connected to the output interface 86.

Here, among the signals supplied to the ECU 8, the turbine revolutions Nt match the primary pulley revolutions (input shaft revolutions) Nin during forward travel in which the forward clutch C1 of the forward/rearward travel switching apparatus 3 is engaged, and the secondary pulley revolutions (output shaft revolutions) Nout correspond to the vehicle speed V. Also, the accelerator operation amount Acc indicates the driver's requested output amount.

The shift lever 9 is selectively operated to respective positions such as a parking position ‘P’ for parking the vehicle, a reverse position ‘R’ for rearward travel, a neutral position ‘N’ where power transmission is blocked, a drive position ‘D’ for forward travel, a manual position ‘M’ where it is possible to use a manual operation to increase or reduce the gear ratio γ of the belt-type continuously variable transmission 4 during forward travel, and so on.

In the manual position ‘M’, a downshift position and an upshift position for increasing or decreasing the gear ratio γ, or alternatively, a plurality of range positions where it is possible to select from a plurality of gear change ranges with differing upper limits (side where the gear ration γ is small) of a gear change range, or the like are provided.

The lever position sensor 110, for example, is provided with a plurality of ON/OFF switches or the like that detect that the shift lever 9 has been operated and moved to the parking position ‘P’, the reverse position ‘R’, the neutral position ‘N’, the drive position ‘D’, the manual position ‘M’, the upshift position or the downshift position, or a range position, and so on. Note that in order to change the gear ratio γ with a manual operation, it is also possible to provide, separate from the shift lever 9, a downshift switch and an upshift switch, or a lever or the like, on a steering wheel or the like.

Based on the above output signals of the various sensors and the like, the ECU 8 executes output control of the engine 1, the above gear change speed control and belt-clamping pressure control of the belt-type continuously variable transmission 4, engagement/release control of the lockup clutch 24, and so on. Further, the ECU 8 executes a “normalcy determination of upshift gear change state” described below.

Output control of the engine 1 is executed using the throttle motor 13, the fuel injection apparatus 14, the ignition apparatus 15, the ECU 8, and so on.

—Normalcy Determination of Upshift Gear Change State—

In this example, a normalcy determination of components such as the upshift gear change control solenoid (DS1) 304 (normalcy determination of gear change state) is performed. Specifically, when a determination condition is satisfied that a DS1 gear change duty (upshift duty) is output to the gear change control solenoid (DS1) 304, and also a ratio of the actual amount of sheave position movement relative to the target amount of sheave position movement of the movable sheave 411 of the primary pulley 41 (the following degree of the actual gear ratio relative to the target gear ratio) is not less than a prescribed value, the upshift gear change state is determined to be normal. Also, even if output of the DS1 gear change duty (upshift duty) ceases during an upshift gear change, the upshift gear change state is determined to be normal if the upshift gear change speed is fast.

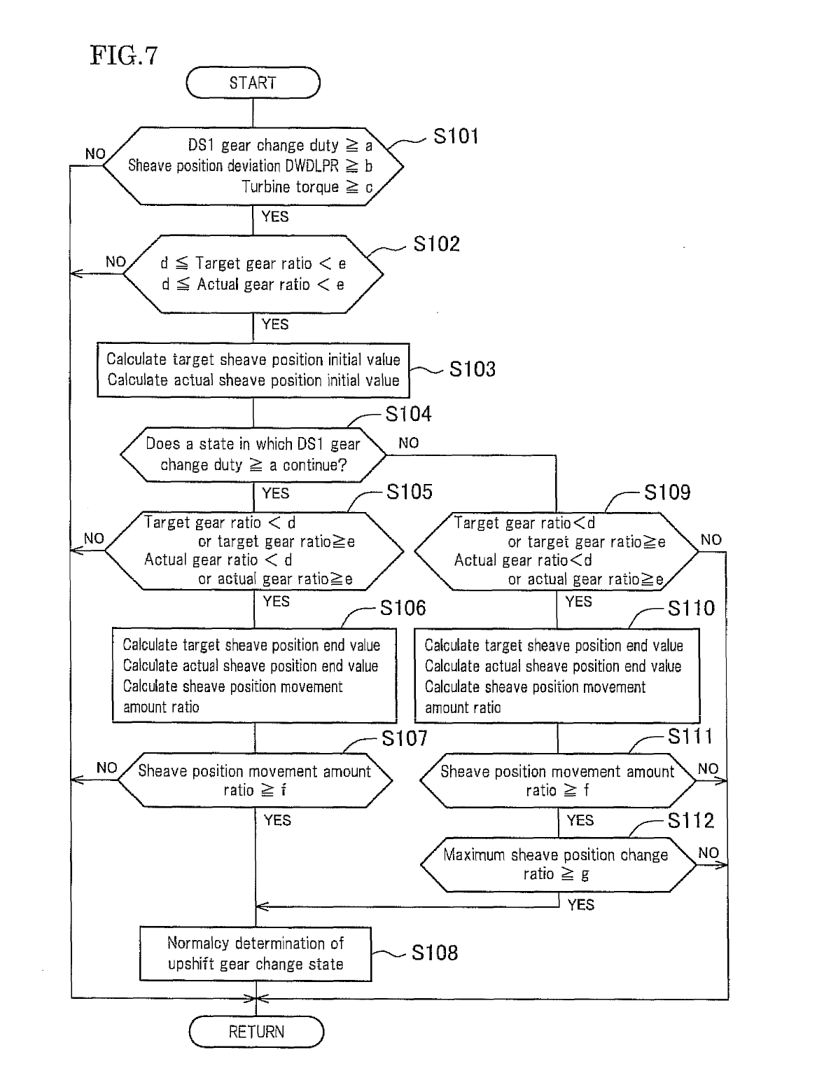

An exemplary specific control therefor (normalcy determination process of the upshift gear change state) will be described with reference to a flowchart shown in FIG. 7. The process routine in FIG. 7 is repeatedly executed every predetermined time period (for example, several ms) by the ECU 8.

First, the target sheave position used in the normalcy determination process of this example is obtained from a target gear ratio RATIO T that corresponds to the above-described input side target revolutions Nint. Furthermore, the actual sheave position is obtained by the following expression: actual gear ratio RATIO (RATIO=actual primary pulley revolutions (input shaft revolutions) Nin/actual secondary pulley revolutions (output shaft revolutions) Nout).

In addition, in the determination process of this example, an actual sheave position change ratio (change ratio of the position of the movable sheave 411 of the primary pulley 41) DWDR from the point in time when the DS1 gear change duty has been output (a point in time when a condition that DS1 gear change duty a has been satisfied, which is described later) is calculated. The calculation of the actual sheave position change ratio DWDR continues until the upshift gear change ends, even if output is switched from the DS1 gear change duty to the DS2 gear change duty during an upshift gear change. With a peak hold process being performed during the above period until the upshift gear change ends, a maximum sheave position change ratio DWDRmax during an upshift gear change (see FIG. 9) is obtained.

Next, each step in the determination process routine in FIG. 7 will be described.

In step ST101, a determination is made as to whether the following three conditions are all satisfied: [DS1 gear change duty is not less than a determination threshold value a], [deviation DWDLPR between the target sheave position and the actual sheave position is not less than a determination threshold value b] and [estimated turbine torque TT is not less than a determination threshold value c]. When the determination result is affirmative, the routine proceeds to step ST102. When the determination result in step ST101 is negative, the routine returns.

Here, the determination threshold value a set for the DS1 gear change duty is set, through adjustment, to a value with which it is possible to determine that the upshift gear change control solenoid (DS1) 304 is in an operating state (a state in which the valve is open and a control hydraulic pressure is output).

The determination threshold value b for the deviation DWDLPR between the target sheave position and the actual sheave position, is a threshold value for determining that the target gear ratio RATIO T is in the upshift side relative to the actual gear ratio RATIO (that the upshift gear change is reliably performed), and is set to a value adjusted through experiments, calculation or the like.

With respect to the determination threshold value c set for the estimated turbine torque TT, for example, a point is taken into account that in the belt-type continuously variable transmission 4, in the case where a component such as the gear change control solenoid (DS1) 304 for upshift gear change control is at fault, upshift gear change may be performed even if the input torque (turbine torque TT) of the belt-type continuously variable transmission 4 is low, and as a result the upshift gear change state is erroneously determined to be normal. The determination threshold c is therefore set to a value obtained by adjusting, through experiments, calculation or the like, a positive torque (turbine torque TT) having a sufficient magnitude to prevent such an erroneous determination.

Note that the turbine torque TT can be calculated based on the engine torque Te, the torque ratio of the torque converter 2, and an input inertia torque. The engine torque Te can be calculated from, for example, the throttle opening degree θth and the engine revolutions Ne. The torque ratio is a function of [the primary pulley revolutions (input shaft revolutions) Nin/engine revolutions Ne]. The input inertia torque can be calculated from the temporal change amount in the primary pulley revolutions (input shaft revolutions) Nin.

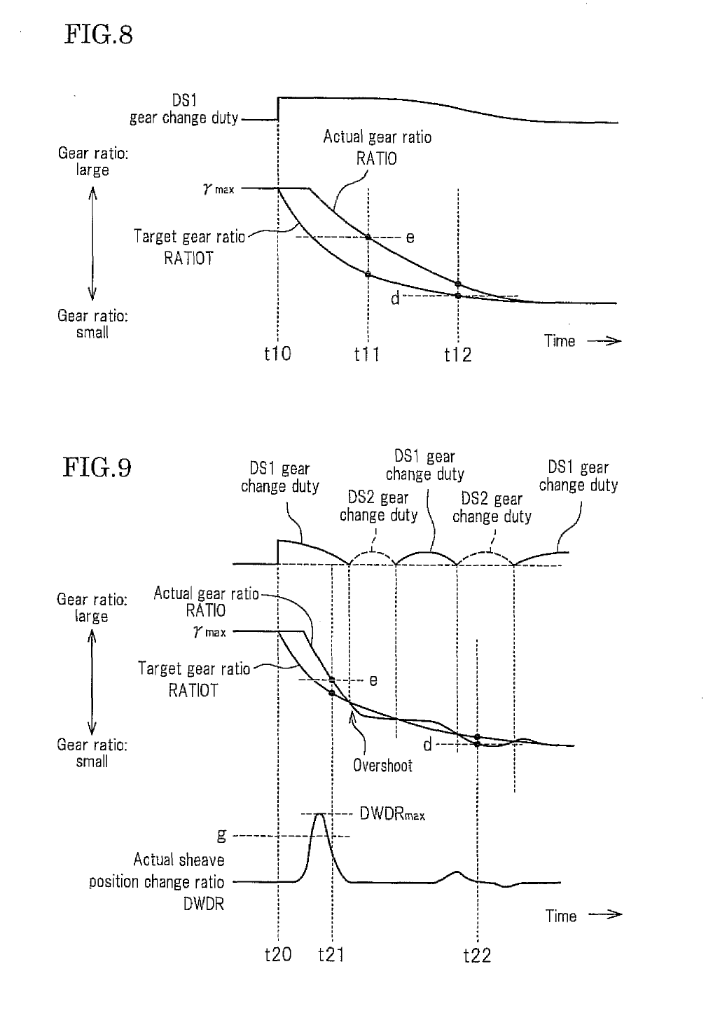

In step ST102, a determination is made as to whether both the target gear ratio RATIO T and the actual gear ratio RATIO satisfy the respective conditions, [d≦RATIO T<e] and [d≦RATIO<e]. Specifically, on the condition that both the target gear ratio RATIO T and the actual gear ratio RATIO are not less than an end determination value d, it is determined whether both the target gear ratio RATIO T and the actual gear ratio RATIO have become less than a start determination value e. The point in time when the determination result has become affirmative is treated as the start point (for example, a start point t11 in FIG. 8), and the routine proceeds to step ST103. If the determination result in step ST102 is negative, the routine returns.

In step ST 103, a target sheave position initial value LINTGTPS and an actual sheave position initial value LINGTPS at the point in time when the start point is reached are calculated. The target sheave position initial value LINTGTPS is calculated from the target gear ratio RATIO T corresponding to the input side target revolutions Nint at the point in time when the start point is reached. Also, the actual sheave position initial value LINGTPS is calculated from the actual gear ratio RATIO (primary pulley revolutions (input shaft revolutions) Nin/secondary pulley revolutions (output shaft revolutions) Nout) at the point in time when the start point is reached.

Next, in step ST104, a determination is made as to whether a state continues in which the DS1 gear change duty is not less than the determination threshold value a (the upshift gear change instruction continues), and when the determination result is affirmative, the routine proceeds to step ST 105. When the determination result in step ST104 is negative, the routine proceeds to step ST109.

In Step ST105, a determination is made as to whether the target gear ratio RATIO T or the actual gear ratio RATIO satisfies the condition [(RATIO T<d) or (RATIO T≧e)], or the condition [(RATIO<d) or (RATIO≧e)].

This step ST105 is for determining whether, after the target gear ratio RATIO T and the actual gear ratio RATIO have reached the above-described start point (for example, the start point t11 in FIG. 8), one of the target gear ratio RATIO T or the actual gear ratio RATIO has become less than the end determination value d. The point in time when the determination result has become affirmative is treated as an end point (for example, an end point t12 in FIG. 8), and the routine proceeds to step ST106. In the case where the determination result in step ST 105 is negative, the routine returns.

In step ST106, a target sheave position end value LINTGTPE and an actual sheave position end value LINGTPE at the point in time when the end point is reached are calculated. Furthermore, by using the target sheave position end value LINTGTPE and the actual sheave position end value LINGTPE as well as the target sheave position initial value LINTGTPS and the actual sheave position initial value LINGTPS calculated in step ST103 described above, a sheave position movement amount ratio DWDLHI is calculated with an arithmetic expression [(LINGTPE−LINGTPS)/(LINTGPTE−LINTGTPS)].

Not that in step ST106, the target sheave position end value LINTGTPE is calculated from the target gear ratio RATIO T corresponding to the input side target revolutions Nint at the point in time when the end point is reached. Also, the actual sheave position end value LINGTPE is calculated from the actual gear ratio RATIO (primary pulley revolutions (input shaft revolutions) Nin/secondary pulley revolutions (output shaft revolutions) Nout) at the point in time when the end point is reached.

In step ST107, it is determined whether the sheave position movement amount ratio DWDLHI calculated in step ST106 is not less than a normalcy determination threshold value f, and when the determination result is affirmative (DWDLHI≧f), the upshift gear change state is determined to be normal (step ST108). When the determination result in step ST107 is negative (DWDLHI<f), the procedure returns.

On the other hand, also in the case where the determination result in step ST104 is negative, that is, output of the DS1 gear change duty is not continued and is switched to the output of the DS2 gear change duty, the sheave position movement amount ratio DWDLHI is calculated through processes similar to those in steps ST105 and ST106 described above (steps ST109 and ST110).

Next, in step ST111, it is determined whether the sheave position movement amount ratio DWDLHI calculated in step ST110 is not less than the normalcy determination threshold value f, and when the determination result is affirmative (DWDLHI≧f), the routine proceeds to step ST112. When the determination result in step ST111 is negative, the routine returns.

In step ST112, it is determined whether the maximum actual sheave position change ratio DWDRmax during an upshift gear change is not less than a determination threshold value g. When the determination result is affirmative (DWDRmax≧g), it is determined that the upshift gear change speed is fast and the transmission is capable of performing an upshift gear change, and the upshift gear change state is thus determined to be normal (step ST108). When the determination result in step ST112 is negative, the routine returns.

Here, the normalcy determination threshold value f set for the sheave position movement amount ratio DWDLHI is, for example, set in the following manner: The sheave position movement amount ratio DWDLHI (the following degree of the actual gear ratio RATIO relative to the target gear ratio RATIO T) in a state in which the upshift gear change control solenoid (DS1) 304 operates properly, and the upshift gear change is normally performed is obtained through experiments, calculation, or the like; and the obtained sheave position movement amount ratio is adjusted while taking into account a certain degree of allowance (allowable value for the following degree), and the adjusted value is set as the normalcy determination threshold value f.

Also, for the determination threshold value g set for the maximum actual sheave position change ratio DWDRmax, for example, a lower limit value of the gear change speed at which overshooting (overshooting relative to the target gear ratio RATIOT) occurs in the actual gear ratio RATIO due to an actual upshift gear change is obtained through experiments, calculations, or the like. The obtained gear change speed lower limit value can be adjusted while taking into account a certain degree of allowance (allowable value for the following degree), and the adjusted value is set as the determination threshold value g.

A specific example of the normalcy determination process of the upshift gear change state as described above will be described with reference to FIGS. 8 and 9. Note that FIGS. 8 and 9 show an example of an upshift gear change when a vehicle starts moving.

First, in the time chart shown in FIG. 8, the target gear ratio RATIO

T transitions to the upshift side (the side with a smaller gear ratio) from a point in time t10 when the output of the DS1 gear change duty has started (a point in time when the condition that DS1 gear change duty ≧ a has been satisfied). Along with this transition, the actual gear ratio RATIO transitions to the upshift side.

In the example of FIG. 8, after gear change control has started, the output of the DS1 gear change duty continues in a state where the target gear ratio RATIO T is on the upshift side (the side with a smaller gear ratio) relative to the actual gear ratio RATIO, so the normalcy determination of the upshift gear change state is performed. Specifically, the target sheave position initial value LINTGTPS and the actual sheave position initial value LINGTPS are calculated at a point in time t11 (start point t11), at which target gear ratio RATIO T becomes less than the start determination value e (RATIO T<e), and then the actual gear ratio RATIO becomes less than the start determination value e (RATIO<e). Thereafter, the target sheave position end value LINTGTPE and the actual sheave position end value LINGTPE are calculated at a point in time t12 (end point t12), at which the target gear ratio RATIO T becomes less than the end determination value d (RATIO T<d). Then, by using the target sheave position initial value LINTGTPS and the actual sheave position initial value LINGTPS calculated at the start point t11, as well as the target sheave position end value LINTGTPE and the actual sheave position end value LINGTPE calculated at the end point t12, the sheave position movement amount ratio DWDLHI is calculated with the above-stated arithmetic expression. When the calculation result is not less than the normalcy determination threshold value f described above, the upshift gear change state is determined to be normal.

In this manner, in a state where the target gear ratio RATIO T is on the upshift side relative to the actual gear ratio RATIO, and the output of the DS1 gear change duty (upshift gear change instruction) continues during an upshift gear change, the normalcy determination of the upshift gear change state is performed.

Here, as shown in the time chart in FIG. 9, when the upshift gear change speed is fast and the actual gear ratio RATIO overshoots the target gear ratio RATIO T, the DS1 gear change duty output (upshift gear change instruction) is switched to the DS2 gear change duty output (downshift gear change instruction). In such a situation (no output of the DS1 gear change duty), the normalcy determination of the upshift gear change state is stopped under conventional controls; therefore, the normalcy determination of the upshift gear change state is performed less frequently.

In contrast, in this example, even if the DS1 gear change duty output is switched to the DS2 gear change duty output during an upshift gear change, in the case where the upshift gear change speed is fast (not less than a determination threshold), specifically, in the case where the maximum actual sheave position change ratio DWDRmax during an upshift gear change is not less than the determination threshold value g as shown in FIG. 9, it is determined that the transmission is capable of performing an upshift gear change, and the upshift gear change state is determined to be normal (steps ST109 to ST112 in FIG. 7). As a result, the normalcy determination of the upshift gear change state can be performed more frequently.

Next, the example in FIG. 9 will be specifically described. First, the target gear ratio RATIO T transitions to the upshift side (the side with a smaller gear ratio) from a point in time t20 when the output of the DS1 gear change duty has started (a point in time when the condition that DS1 gear change duty a has been satisfied), and along with this transition the actual gear ratio RATIO transitions to the upshift side. However, since the upshift gear change speed is fast, the time at which the actual gear ratio RATIO becomes less than the start determination value e (RATIO<e) after the target gear ratio RATIO T has become less than the start determination value e (RATIOT<e), namely a point in time t21 (start point t21), comes earlier than in the example of FIG. 8. In this manner, when the upshift gear change speed is fast, a situation arises in which after the start time t21 has been reached, the actual gear ratio RATIO overshoots to the upshift side relative to the target gear ratio RATIO T, so that the DS1 gear change duty output is switched to the DS2 gear change duty output. In this example, however, the normalcy determination of the upshift gear change state is continued in spite of such a situation (the processes in steps ST109 to ST112 in FIG. 7 are executed).

Then, the sheave position movement amount ratio DWDLHI is calculated at a point in time t22 (end point t22), at which one of the actual gear ratio RATIO or the target gear ratio RATIO T (the actual gear ratio RATIO in the case of the example in FIG. 9) has become less than the end determination value d (RATIO<d). When the calculation result is not less than the above-described normalcy determination threshold value f, and also the maximum actual sheave position change ratio DWDRmax obtained during an upshift gear change is not less than the determination threshold value g, the upshift gear change state is determined to be normal.

### Other Embodiments

In the foregoing examples, although the start determination value and the end determination value for the target gear ratio RATIO T, and the start determination value and the end determination value for the actual gear ratio RATIO are the same values (start determination value e and end determination value d), the present invention is not limited to this. Different values may be used as the start determination value and the end determination value for the target gear ratio RATIO T, and the start determination value and the end determination value for the actual gear ratio RATIO.

In the foregoing examples, although an example is described in which the present invention is applied to a continuously variable transmission provided with the upshift gear change control solenoid (DS1) 304 and the downshift gear change control solenoid (DS2) 305, the present invention is not limited to this. The present invention can be applied to gear change control of continuously variable transmissions having another gear change control means without the gear change control solenoids DS1 and DS2 being mounted therein.

In the above examples, the invention was applied to the control apparatus of an automatic transmission of a vehicle in which a gasoline engine has been mounted, but this is not a limitation; the invention is also applicable to the control apparatus of an automatic transmission of a vehicle in which another engine, such as a diesel engine, has been mounted. Also, other than an engine (internal combustion engine), the power source of the vehicle may be an electric motor or alternatively a hybrid power source provided with both an engine and an electric motor.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

### INDUSTRIAL APPLICABILITY

The present invention is not limited to FF (front engine/front drive) type vehicles, and is applicable to FR (front engine/rear drive) type vehicles and four wheel drive vehicles.

### DESCRIPTION OF REFERENCE NUMERALS

1 Engine

4 Belt-type continuously variable transmission

41 Primary pulley

411 Movable sheave

413 Hydraulic actuator

42 Secondary pulley

421 Movable sheave

423 Hydraulic actuator

43 Belt

101 Engine revolutions sensor

105 Primary pulley revolutions sensor

106 Secondary pulley revolutions sensor

20 Hydraulic pressure control circuit

304 Upshift gear change control solenoid (DS1)

305 Downshift gear change control solenoid (DS2)

301 Upshift gear change control valve

302 Downshift gear change control valve

8 ECU

### Prior Art Document

### Patent Document

[Patent Document 1] JP 2007-177833A

1. A continuously variable transmission control apparatus comprising:
a primary pulley;
a secondary pulley;
a belt wrapped around the primary pulley and the secondary pulley;
an actuator that changes a groove width of a pulley groove by moving a sheave of the primary pulley;
a gear change control means for performing gear change by controlling the actuator in response to an upshift gear change instruction or a downshift gear change instruction;
a normalcy determination means for determining that an upshift gear change state is normal when the upshift gear change instruction is present, and that a following degree of an actual gear ratio relative to a target gear ratio is not less than a normalcy determination threshold,
wherein even if the upshift gear change instruction ceases during an upshift gear change, the normalcy determination means determines that an upshift gear change state is normal in a case where the following degree of an actual gear ratio relative to a target gear ratio is not less than the normalcy determination threshold, and a maximum value of a gear change speed during an upshift gear change is not less than a determination threshold.

2. The continuously variable transmission control apparatus according to claim 1,
wherein the normalcy determination means determines that an upshift gear change state is normal when the upshift gear change instruction is present, and a ratio of an actual sheave position movement amount relative to a target sheave position movement amount of the sheave of the primary pulley is not less than a normalcy determination threshold, and even if the upshift gear change instruction ceases during an upshift gear change, determines that the upshift gear change state is normal in a case where the ratio of the actual sheave position movement amount relative to the target sheave position movement amount is not less than the normalcy determination threshold, and a maximum actual sheave position change ratio of the sheave of the primary pulley during upshift gear change is not less than a determination threshold.

3. The continuously variable transmission control apparatus according to claim 1,
wherein an actuator of the primary pulley is a hydraulic actuator that is driven by flow-in or flow-out of a hydraulic fluid, and is configured such that the amount of flow-in or flow-out of the hydraulic fluid in the hydraulic actuator is controlled with a solenoid valve, and the upshift gear change instruction is an upshift gear change duty signal output to the solenoid valve.

4. The continuously variable transmission control apparatus according to claim 2,
wherein an actuator of the primary pulley is a hydraulic actuator that is driven by flow-in or flow-out of a hydraulic fluid, and is configured such that the amount of flow-in or flow-out of the hydraulic fluid in the hydraulic actuator is controlled with a solenoid valve, and the upshift gear change instruction is an upshift gear change duty signal output to the solenoid valve.
